(19) United States
(12) Patent Application Publication
(10) Pub. No.: US 2004/0012243 A1
(43) Pub. Date: Jan. 22, 2004

(54) Wheel

(76) Inventor: Marcelino Marcao, Limeira (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/362,665

(22) PCT Filed: Aug. 10, 2001
(86) PCT No.: PCT/BR01/00099

(30) Foreign Application Priority Data
Aug. 21, 2000 (BR) PI 0003716-8

(51) Int. Cl. B60B 1/00

(52) U.S. Cl. 301/5.1

(57) ABSTRACT

A wheel adapted for use by an automotive vehicle is provided. Such a wheel comprises a circular rim having an outer edge and defining an axis and a transverse plane perpendicular to the axis. A disc is operably engaged with the outer edge of the rim so as to be in coaxial relation with the rim. The disc has a plurality of radially-extending spokes and defines a vent window between successive spokes, wherein the vent window has a radially outermost portion. A valve defining an axis, and having a mounting end and a beak end, is adapted for filling and controlling pressure in a tire mounted on the wheel. A bore defined by the rim is configured to receive the valve therein such that the mounting end is operably engaged with the bore at a mounting point and the beak end extends outwardly of the rim and through the vent window. The bore and the valve are configured such that an angle between the transverse plane and the axis of the valve is substantially less than an angle between the transverse plane and a line defined by the mounting point and the radially outermost portion of the vent window. Other wheels are also provided.

### BACKGROUND OF THE INVENTION

1. Field of the Invention

The present invention relates to a wheel provided with a new arrangement of a bore for receiving a calibration valve of a tire.

2. Description of Related Art

Conventional wheels of stamped steel for use in automotive vehicles are made up of a substantially cylindrical rim, on which the tire is fixed, and a disc stamped in carbon steel, arc-welded, preferably in four different regions substantially perpendicular to each other. However, the wheels in question have a number of drawbacks that make their use little suitable for certain types of vehicles.

Considering these drawbacks, the present applicant has developed an integrated stamped wheel comprising a rim and a disc having at least one spoke with a cross-section substantially in the form of an open profile and being associated with the rim, so that the opening of the profile of the spoke will be facing the face of the wheel that is associable with the hub of the wheel of the vehicle. This wheel is described in patent application PI 9701349-8.

However, in the wheel in question the valve for filling and controlling the pressure of the tire would remain in the same position in which it was situated in the conventional wheels of stamped steel. This positioning created a drawback, requiring an additional operation for manufacturing the wheel, this additional operation creating a recess and/or a bore at a given point of the outer portion of the disc of this wheel. The recess and/or bore further caused another drawback, which was the unbalancing of the wheel due to the withdrawal of material in this region. In addition, in order to position the beak of the valve correctly and to bring about an easy calibration of the tire, the valve body had a long length.

### BRIEF SUMMARY OF THE INVENTION

The present invention provides a wheel, especially for use in automotive vehicles in which the valve used for filling and controlling the pressure of the tire is positioned so as to avoid the need for an operation for creating a recess and/or a bore at a certain point of the outer portion of the disc of the wheel. Such a wheel comprises a rim, an outer disc coaxial with the rim, the disc being provided with consecutive spokes, a vent window being provided between every two consecutive spokes, the rim being provided with a bore for placing a valve for filling and controlling the pressure of the tire, the access to the valve, when it is mounted in the bore, being provided substantially through the vent window. Optionally, a wheel is provided in which the longitudinal axis of the bore for placing the valve extends through the vent window.

### BRIEF DESCRIPTION OF THE SEVERAL VIEWS OF THE DRAWING(S)

The present invention will now be described in greater detail with reference to an embodiment represented in the drawings.

FIG. 1 is a side cross-section view of the wheel of the prior art;

FIG. 2 is a front view of the wheel of the prior art;

FIG. 3 is a side cross-section view of a first embodiment of the new positioning of the valve for controlling tire pressure of the present invention;

FIG. 4 is a side cross-section view of a second embodiment of the new positioning of the valve for controlling tire pressure of the present invention; and

FIG. 5 is a front view of the wheels with the new positioning of the valve of the present invention.

### DETAILED DESCRIPTION OF THE INVENTION

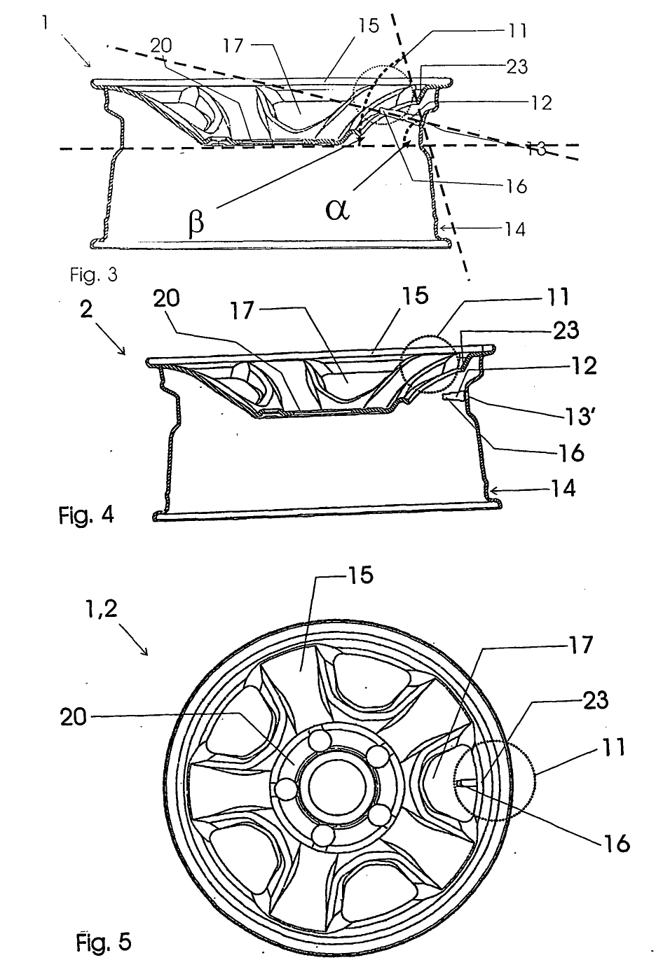

According to FIGS. 3-5, the present invention has two preferred embodiments applied to wheels 1, 2. The wheels 1, 2 are especially usable in automotive vehicles and comprise a substantially cylindrical rim 14 and a disc 15 that is external and coaxial with the rim 14, made of stamped steel and having five vent windows 17 for the brake system ventilation.

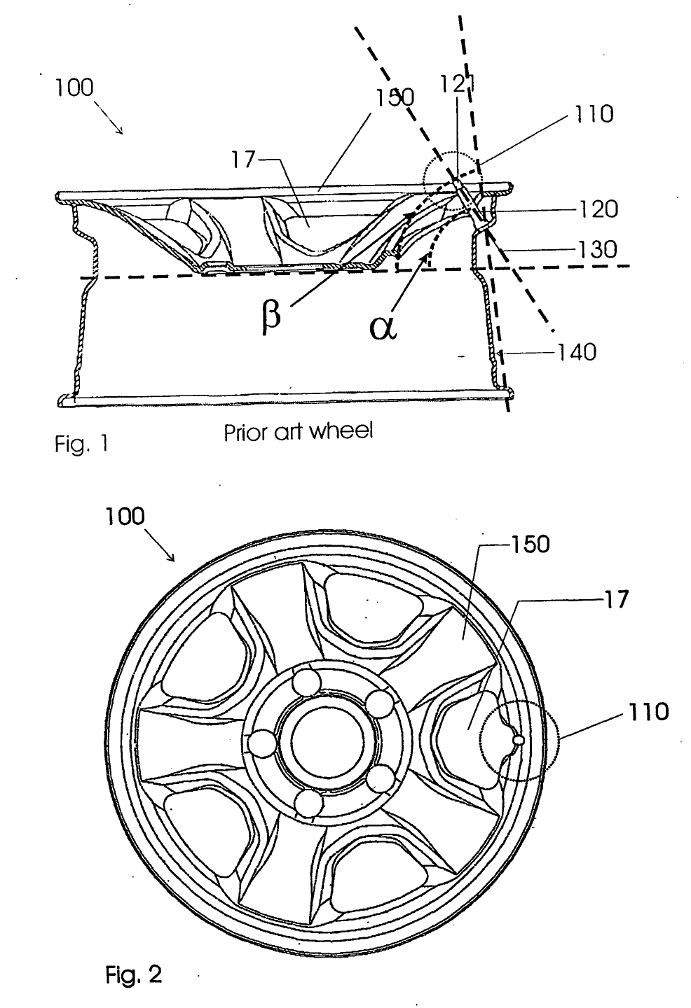

As shown in FIGS. 1 and 2, referring to the wheel 100 of the prior art, which is composed of a disc 150 and a rim 140, that the region 110 of the wheel 100, located at a substantially external attachment portion of the disc 150, has a recess and/or a bore for placing the valve 120 of filling and controlling the pressure of the tire. The valve is fixed to the rim 140 in a bore for placing the valve 130. However, due to the inclination of the longitudinal axis of the bore 130, one makes a recess and/or bore at a determined point of the outer portion of the disc 150, in order to bring about the correct positioning of the beak 121 of the valve 120 on the disc 150. This recess and/or bore is made in an additional step to be carried out with the disc 150 while manufacturing the wheel 100. This additional step of manufacture renders the production cost of the wheel 100 high, besides prolonging the manufacture time. To make the situation still worse, the recess and/or bore causes unbalancing of the wheel 100 due to the removal of material in an asymmetrical way with respect to its mass center. This wheel is described in detail in patent application PI 9701349-8, the owner of which is the applicant itself.

In the wheel 1, 2 shown in FIGS. 3-5, the valve 12 for filling and controlling the pressure of the tire is fixed to the rim 14 in a bore for placing the valve 13, 13′, the direction of the longitudinal axis forms an angle α with the plane defined by the central portion 20 of the disc 15. The projection of the central point (not shown) of the bore 13, 13′ as far as the middle portion of the outer edge 23 of one of the windows 17 forms an angle β. Unlike the wheel 100 of the prior art, the opening value of the angle α is substantially lower than the opening value of the angle β, enabling the valve 12 to be installed without the need for a recess and/or bore, so that the wheel 1, 2 can accommodate its beak 16. Therefore, access to the beak 16 of the valve 12, when mounted in the bore 13, 13′, is provided substantially through the vent window 17.

The beak 16 is located in a region 11 at a substantially external portion of the disc 15, the region 11 being substantially adjacent to said window 17. In the wheel 1, relating to a first embodiment, the longitudinal axis of the bore 13 for placing the valve 12 extends through the vent window 17, presenting a little angle α.

The present invention brings about the economy of a step of production of the wheel 1, 2, since a recess and/or bore in the disc 15 is not required for the valve 12 to be correctly accommodated. In addition, since no removal of material in an asymmetric way with respect to the mass center of the wheel 1, 2 is required, it presents better inherent balancing, having better efficiency of use and an important commercial advantage. Also, this configuration enable one to use shorter valves 12, which have their beaks 16 positioned in a more convenient way, so that the end user will have more ease in altering the calibration of the tire.

Although the wheel 1, 2 of the detailed description has five vent windows 17, it is evident that the present invention may by applied to a wheel with a different number of windows.

A preferred embodiment having been described, one should understand that the scope of the present invention embraces other possible variations and is limited only by the contents of the accompanying claims, the possible equivalents being included therein.

That which is claimed:

1. A wheel adapted for use by an automotive vehicle, said wheel comprising:
a circular rim having an outer edge and defining an axis and a transverse plane perpendicular to the axis;
a disc operably engaged with the outer edge of the rim so as to be in coaxial relation with the rim, the disc having a plurality of radially-extending spokes and defining a vent window between successive spokes, the vent window having a radially outermost portion;
a valve defining an axis and having a mounting end and a beak end, the valve being adapted for filling and controlling pressure in a tire mounted on the wheel; and
a bore defined by the rim and configured to receive the valve therein such that the mounting end is operably engaged with the bore at a mounting point and such that the beak end extends outwardly of the rim and through the vent window, the bore and the valve being configured such that an angle between the transverse plane and the axis of the valve is substantially less than an angle between the transverse plane and a line defined by the mounting point and the radially outermost portion of the vent window.

2. A wheel according to claim 1 wherein the vent windows are substantially identical and the rim is angularly disposed with respect to the disc such that the bore corresponds to the radially outermost portion of any of the vent windows.

3. A wheel according to claim 1 wherein the bore defines an axis extending through the vent window when the disc is operably engaged with the rim.

4. A wheel according to claim 1 wherein the valve is configured to extend only through any of the vent windows when operably engaged with the bore.

5. A wheel according to claim 1 wherein the disc further comprises a center portion and a radially outward ring portion having the spokes extending therebetween and wherein the valve is configured to extend through the vent window without extending through the ring portion.

6. A wheel according to claim 1 wherein the disc further defines a mass center, and wherein the disc has a mass distributed substantially symmetrically about the mass center.

7. A wheel according to claim 1 wherein the valve is configured to be substantially linear.

8. A wheel adapted for use by an automotive vehicle, said wheel comprising:
a circular rim having an outer edge and defining an axis and a transverse plane perpendicular to the axis;
a disc having a first surface operably engaged with the outer edge of the rim so as to be in coaxial relation with the rim, the disc having a center portion and a radially outward ring portion with a plurality of radially-extending spokes extending therebetween, the disc further having a second surface directed away from the rim and defining a transverse plane perpendicular to the axis;
a vent window defined between successive spokes, the vent window having a radially outermost portion;
a valve defining an axis and having a mounting end and a beak end, the valve being adapted for filling and controlling pressure in a tire mounted on the wheel; and
a bore defined by the rim and configured to receive the valve therein such that the mounting end is operably engaged with the bore and such that the beak end extends outwardly of the rim and through the vent window without breaking the transverse plane defined by the second surface of the disc.

9. A wheel according to claim 8 wherein the vent windows are substantially identical and the rim is angularly disposed with respect to the disc such that the bore corresponds to the radially outermost portion of any of the vent windows.

10. A wheel according to claim 8 wherein the bore defines an axis extending through the vent window when the disc is operably engaged with the rim.

11. A wheel according to claim 8 wherein the valve is configured to extend only through any of the vent windows when operably engaged with the bore.

12. A wheel according to claim 8 wherein the valve is configured to extend through the vent window without extending through the radially outward ring portion of the disc.

13. A wheel according to claim 8 wherein the valve is configured to extend through the vent window without extending through one of the spokes.

14. A wheel according to claim 8 wherein the disc further defines a mass center, and wherein the disc has a mass distributed substantially symmetrically about the mass center.

15. A wheel according to claim 8 wherein the valve is configured to be substantially linear.
